(19) United States
(12) Patent Application Publication
(10) Pub. No.: US 2009/0173074 A1
(43) Pub. Date: Jul. 9, 2009

(54) INTEGRATED FUEL NOZZLE IFC

(75) Inventors: Thomas Edward Johnson, Greer, SC (US); John Brandon MacMillan, Liberty, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/968,881

(22) Filed: Jan. 3, 2008

(51) Int. Cl. F02C 9/16

(52) U.S. Cl. 60/737

(57) ABSTRACT

Disclosed is a fuel nozzle for a gas turbine including a center body defining one or more fuel passages and an inlet flow conditioner. The inlet flow conditioner includes a substantially tubular hub, a substantially tubular outer land, and a plurality of spars extending radially outwardly from the hub to the outer land. The plurality of spars together with the hub and outer land define a plurality of fluid flow passages capable of removing circumferential and radial variation from fluid flow entering the fuel nozzle. The inlet flow conditioner is formed as a single unitary component. Further disclosed is a method of operating the gas turbine including the fuel nozzle.

### BACKGROUND

The subject invention relates generally to rotary machines. More particularly, the subject invention relates to fuel nozzles for gas turbine engines.

Gas turbines typically include a combustor in which a fuel-air mixture is ignited, generating a combustion gas stream that is routed to a turbine. The combustor typically includes one or more fuel nozzles, which provide an air-fuel mixture to a combustion chamber for ignition. Compressed air is often provided to the fuel nozzles by a compressor, which air is mixed with fuel in the fuel nozzles. Further, the combustors may include inlet flow conditioners, or IFC's, which serve to remove radial and circumferential variation in the flow of air into the fuel nozzle. This allows the nozzle to mix air and fuel uniformly and predictably to precisely achieve desired fuel to air ratios in the combustor. Precise control of fuel to air ratios is required to assure the gas turbine meets emissions and performance requirements.

Currently, IFC's typically comprise a fabricated assembly of sheet metal components. These components, either individually or as an IFC assembly, are then fixed to a corresponding fuel nozzle by welding or other suitable means. This method of fabrication of a fuel nozzle—IFC assembly is costly, and since it relies on the proper positioning of several components, there is unwanted variation in assembly which results in variation in airflow into the nozzle.

### BRIEF DESCRIPTION OF THE INVENTION

A fuel nozzle for a gas turbine includes a center body defining one or more fuel passages and an inlet flow conditioner. The inlet flow conditioner includes a substantially tubular hub, a substantially tubular outer land, and a plurality of spars extending radially outwardly from the hub to the outer land. The plurality of spars together with the hub and outer land define a plurality of fluid flow passages capable of removing circumferential and radial variation from fluid flow entering the fuel nozzle. The inlet flow conditioner is formed as a single unitary component.

A method of operating a gas turbine includes providing an inlet flow conditioner having a substantially tubular hub, a substantially tubular outer land, and a plurality of spars extending radially outwardly from the hub to the outer land. The plurality of spars together with the hub and outer land defining a plurality of fluid flow passages, and the inlet flow conditioner is formed as a single unitary component. Fluid is channeled into the inlet flow conditioner, and circumferential and radial variation is removed from fluid flow in the inlet flow conditioner.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a partial cross-sectional view of a gas turbine;

FIG. 2 is a cross-sectional view of a combustor nozzle including an integral IFC;

FIG. 3 is a partial perspective view of the combustor nozzle of FIG. 2;

FIG. 4 is an end view of an alternative IFC passage;

FIG. 5 is a perspective view of an integral IFC including turning vanes;

FIG. 6 is a cross-sectional view of the integral IFC of FIG. 5; and

FIG. 7 is a cross-sectional view of an alternative embodiment of the integral IFC of FIG. 5.

The detailed description explains embodiments of the invention, together with advantages and features, by way of example with reference to the drawings.

### DETAILED DESCRIPTION OF THE INVENTION

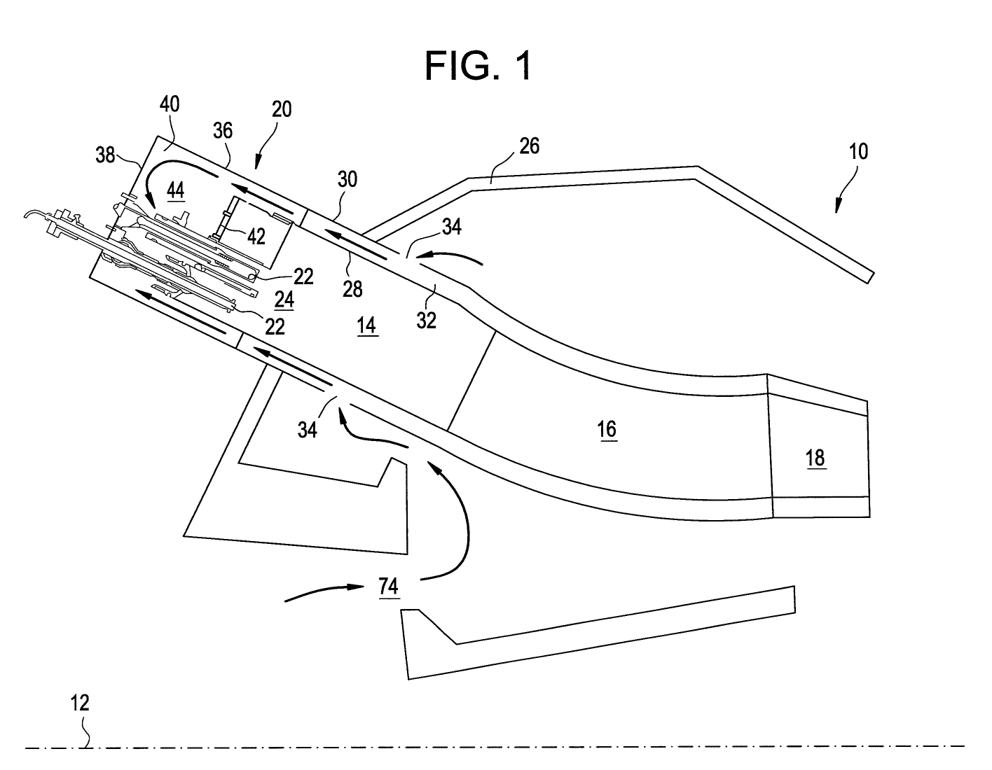

Shown in FIG. 1 is a cross sectional view of a portion of a gas turbine 10 which extends around a gas turbine axis 12. A liner 14, connected to a transition piece 16, channels combustion gases to a turbine 18 from a combustor 20. The combustor 20 utilizes one or more fuel nozzles 22 arranged in the combustor to deliver fuel and air to a combustion zone 24 for ignition and combustion. Fuel is provided to each fuel nozzle 22 by a fuel source (not shown). The liner 14 is positioned in, and may extend through a diffuser case 26, and in the example shown in FIG. 1 is comprised of an inner liner 28 and an outer liner 30 defining a liner channel 32 therebetween. The outer liner 30 includes at least one outer liner opening 34 to allow the introduction of air into the liner channel 32.

The combustor 20 includes a forward case 36 which in this embodiment is connected to the liner 14, and an endcover 38 which is coupled to the forward case 36 with retention hardware (not shown), and with the forward case 36 encloses a combustor volume 40. The one or more fuel nozzles 22 are disposed in a desired arrangement in the combustor volume 40, and are in the example shown in FIG. 1, supportably affixed to the endcover 38. The combustor 20 further includes one or more inlet shrouds 42 which are disposed to substantially divide the combustor volume 40 into an inlet zone 44 and the combustion zone 24, while allowing each fuel nozzle 22 to extend through the inlet shrouds 42 from the inlet zone 44 to the combustion zone 24.

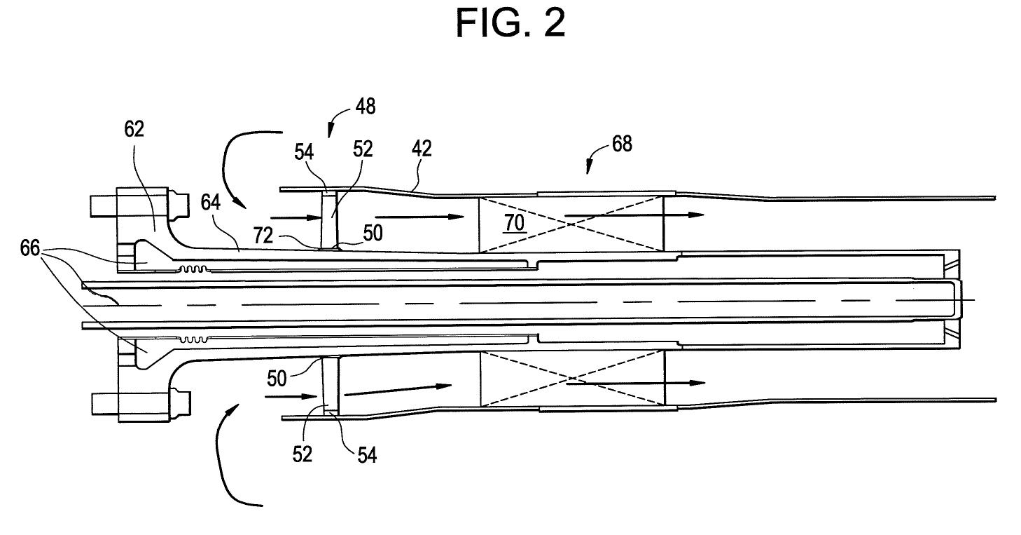

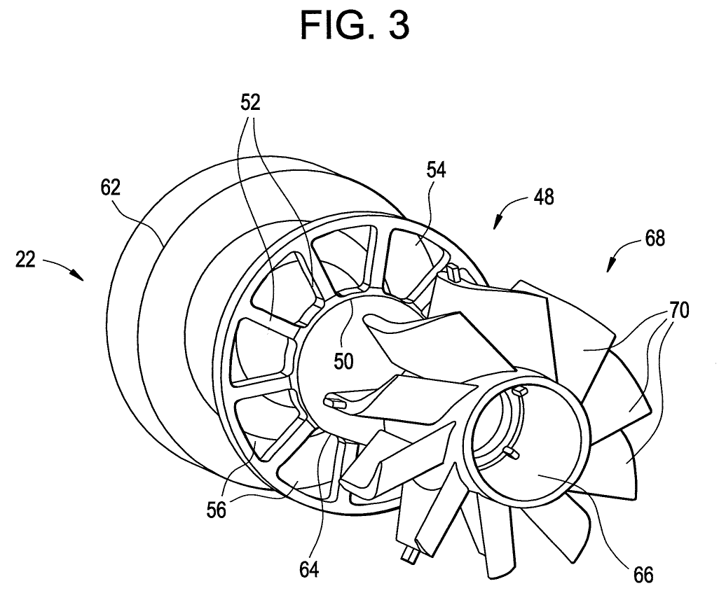

Referring now to FIG. 2, each fuel nozzle 22 includes an integral IFC 48 formed as a single unitary component by, for example, investment casting or by machining from a single piece of unitary stock. The integral IFC 48 includes a hub 50 which is substantially tubular in shape. A plurality of spars 52 extend radially outwardly from the hub 50 to a substantially tubular outer land 54, which in the embodiment shown in FIG. 2 is concentric with the hub 50. The spars 52, outer land 54, and hub 50 define a plurality of IFC passages 56, best shown in FIG. 3, which are configured to properly condition the flow of air into the fuel nozzle 22. An integral IFC 48 which is a single unitary component eliminates inconsistencies in IFC fabrication resulting in improved flow conditioning, and also reduces cost of IFC manufacture.

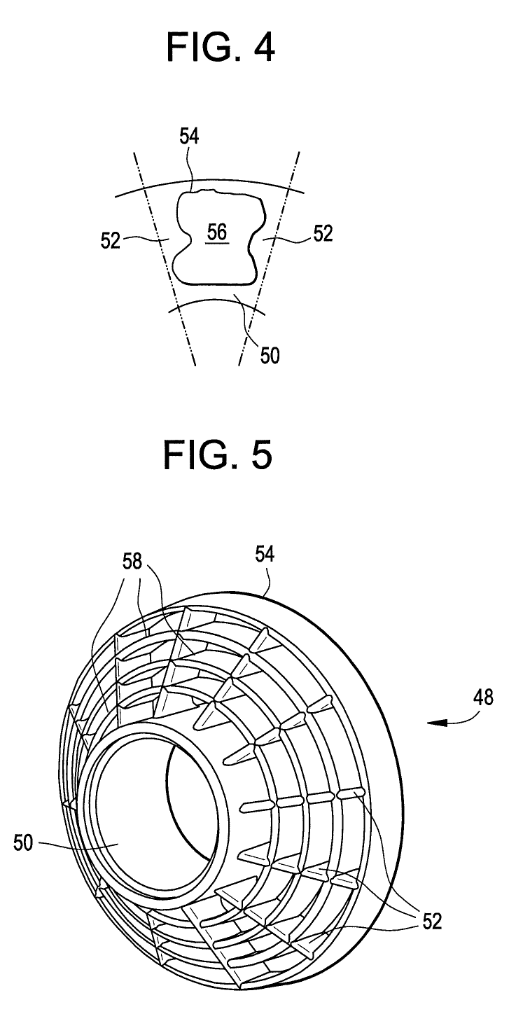

The spars 52 of the integral IFC 48 shown in FIG. 3 are equally-spaced and extend directly radially from the hub 50 to the outer land 54 which results in IFC passages 56 which are equally-sized and uniform sections of an annulus defined by the hub 50 and the outer land 54. Because airflow into the integral IFC 48 may have different characteristics, such as pressure and velocity, depending on circumferential position around the hub 50 and/or radial distance form the hub 50, it is often advantageous to vary the spar 52 spacing with circumferential position and/or vary a profile of the spars 52, the hub 50, and/or the outer land 54 resulting in IFC passages 56 configured to optimize flow conditioning of air entering the integral IFC 48 at that particular radial and circumferential location. For example, as shown in FIG. 4, the non-uniform IFC passage 56 is shown where the spar 52 profiles, the outer land 54 profile, and the hub 50 profile all are substantially non-linear.

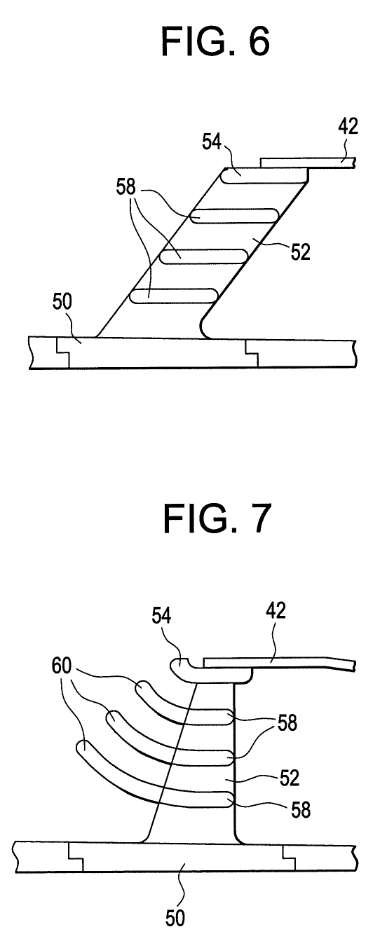

Shown in FIG. 5 is another embodiment of an integral IFC 48. In this embodiment, one or more of the IFC passages 56 are divided by at least one turning vane 58 which extends between spars 52. Turning vanes 58 are utilized to assist in metering and guiding the airflow into the integral IFC 48, and may be of a variety of shapes and sizes as desired to counter a range of pressures and velocities of airflow entering the integral IFC 48. As shown in FIG. 6, for example, the turning vanes 58 may extend directly axially, or alternatively as sown in FIG. 7, the turning vanes 58 may extend substantially axially across the spar 52, then arc radially outward forming a scoop 60 which aids in turning the airflow as shown by the arrows in FIG. 7. The quantities and configurations of turning vanes 58 described herein are merely examples, and it is to be appreciated that other quantities and configurations of turning vanes 58 are contemplated within the scope of the present disclosure.

Referring again to FIGS. 2 and 3, the integral IFC 48 is formed as a single unitary component with fuel nozzle 22 by, for example, casting or by machining from a single piece of stock. The fuel nozzle 22 includes a nozzle base 62 and a center body 64 extending from the nozzle base 62 in one direction. The center body 64 is substantially tubular defining one or more fuel passages 66 therein. The fuel nozzle 22 further includes a swirler 68. The swirler 68 includes a plurality of swirler vanes 70 extending radially outwardly from the center body 64. The swirler vanes 70 are hollow and include a plurality of injection ports (not shown) which are coupled to the one or more fuel passages 66. While the embodiment illustrated in FIG. 3 includes one row of swirler vanes 70, it is to be appreciated that more rows of swirler vanes may be included. In another embodiment, as illustrated in FIG. 2, the integral IFC 48 and the fuel nozzle 22 are formed separately and are joined by, for example, welding or brazing, at joint 72.

Referring again to FIG. 1, air flows, as generally shown by arrows in FIG. 1, to the fuel nozzle 22 from, for example, a compressor (not shown). The air enters a diffuser case 26 through a compressor discharge opening 74. The air flows into the liner channel 32, entering through the openings 34, through the liner channel 34 and into the inlet zone 44. Referring now to FIG. 2, the air passes through the integral IFC 48 where radial and circumferential variation in the flow is removed, and flows toward the swirler 68. Fuel is urged from the fuel source (not shown) through the one or more fuel passages 66 and out of the plurality of injection ports in the swirler vanes 70. The configuration of the swirler vanes 70 causes the fuel to mix with the passing airflow, and the fuel/air mixture travels downstream where it is ignited in the liner 14.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel nozzle for a gas turbine comprising:
a center body defining one or more fuel passages; and
an inlet flow conditioner including:
a substantially tubular hub;
a substantially tubular outer land; and
a plurality of spars extending radially outwardly from the hub to the outer land, the plurality of spars together with the hub and outer land defining a plurality of fluid flow passages capable of removing circumferential and radial variation from fluid flow entering the fuel nozzle, the inlet flow conditioner formed as a single unitary component.

2. The fuel nozzle of claim 1 wherein the inlet flow conditioner and the center body are formed as a single unitary component.

3. The fuel nozzle of claim 2 further including a swirler, the swirler comprising a plurality of swirler vanes extending radially outwardly from the center body.

4. The fuel nozzle of claim 3 wherein the swirler, the inlet flow conditioner, and the center body are formed as a single unitary component.

5. The fuel nozzle of claim 1 wherein the inlet flow conditioner is affixed to the center body by welding.

6. The fuel nozzle of claim 1 wherein the inlet flow conditioner is affixed to the center body by brazing.

7. The fuel nozzle of claim 1 wherein at least one spar of the plurality of spars has a variable profile.

8. The fuel nozzle of claim 1 wherein at least one fluid flow passage includes at least one turning vane disposed circumferentially across the fluid flow passage, the at least one turning vane capable of turning fluid flow entering the inlet flow conditioner.

9. The fuel nozzle of claim 8 wherein the at least one turning vanes extends in a substantially axial direction.

10. The fuel nozzle of claim 8 wherein the at least one turning vane includes a radially outwardly extending portion.

11. A gas turbine comprising:
a turbine; and
a combustor in flow communication with the turbine, the combustor including at least one fuel nozzle, the fuel nozzle having:
a center body defining one or more fuel passages; and
an inlet flow conditioner including:
a substantially tubular hub;
a substantially tubular outer land; and
a plurality of spars extending substantially radially outwardly from the hub to the outer land, the plurality of spars together with the hub and outer land defining a plurality of fluid flow passages capable of removing circumferential and radial variation from fluid flow entering the fuel nozzle, the inlet flow conditioner formed as a single unitary component.

12. The gas turbine of claim 11 wherein the inlet flow conditioner and the center body are formed as a single unitary component.

13. The gas turbine of claim 12 further including a swirler, the swirler comprising a plurality of swirler vanes extending radially outwardly from the center body.

14. The gas turbine of claim 13 wherein the swirler, the inlet flow conditioner, and the center body are formed as a single unitary component.

15. The gas turbine of claim 11 wherein at least one spar of the plurality of spars has a variable profile.

16. The gas turbine of claim 11 wherein at least one fluid flow passage includes at least one turning vane disposed circumferentially across the fluid flow passage, the at least one turning vane capable of turning fluid flow entering the inlet flow conditioner.

17. The gas turbine of claim 16 wherein the at least one turning vane extends in a substantially axial direction.

18. The gas turbine of claim 16 wherein the at least one turning vane includes a radially outwardly extending portion.

19. A method of operating a gas turbine comprising:
providing an inlet flow conditioner having a substantially tubular hub, a substantially tubular outer land, and a plurality of spars extending radially outwardly from the hub to the outer land, the plurality of spars together with the hub and outer land defining a plurality of fluid flow passages, the inlet flow conditioner formed as a single unitary component;
channeling fluid into the inlet flow conditioner; and
removing circumferential and radial variation from fluid flow in the inlet flow conditioner.

20. The method of claim 19 further wherein channeling the fluid into the inlet flow conditioner includes turning the fluid flow with at least one turning vane disposed circumferentially across at least one fluid flow passage of the plurality of fluid flow passages.
